(19) United States
(12) Patent Application Publication
(10) Pub. No.: US 2013/0043676 A1
(43) Pub. Date: Feb. 21, 2013

(54) OVERMOLDED SEAL FOR BARBED TUBING CONNECTION

(71) Applicant: Kenneth D. Baker, Ambler, PA (US)

(72) Inventor: Kenneth D. Baker, Ambler, PA (US)

(73) Assignee: NEWAGE INDUSTRIES, INC., Southampton, PA (US)

(21) Appl. No.: 13/587,273

(22) Filed: Aug. 16, 2012

Related U.S. Application Data
(60) Provisional application No. 61/523,980, filed on Aug. 16, 2011.

(51) Int. Cl. F16L 13/10; F16L 21/08; F16L 21/00

(52) U.S. Cl. 285/286.1; 285/285.1; 285/417

(57) ABSTRACT

A barbed fitting tubing assembly utilizes a thermoplastic tube which is pressed onto a barbed thermoplastic fitting of a device, for example, such as a filter. A thermoplastic sleeve is molded over the tubing where it engages the barbed fitting as well as the end of the fitting where it connects to the device such that the overmolded sleeve engages in an over-mold groove in the fitting so that it is form-locked in position. The tubing, the barbed fitting and the overmolded thermoplastic sleeve are all made of a thermoplastic material and the overmolded thermoplastic sleeve is installed such that such that at least one of a cross-linked chemical bond or a physical mechanical interlocked connection is formed to provide a leak-proof connection.

CROSS-REFERENCE TO RELATED APPLICATIONS

This application claims the benefit of U.S. Provisional Application No. 61/523,980, filed Aug. 16, 2011, which is incorporated herein by reference as if fully set forth.

### BACKGROUND

Many industries utilize thermoplastic tubing that is connected to various devices using a barbed fitting. Typically, the connection of the tubing to the barbed fitting is accomplished by pressing the tubing onto the barb so that the barbs on the outside of the fitting on the device engage with the I.D. of the tubing in order to form the connection. The tubing is expanded as it is pressed over the barbs and is engaged due to the tapered profile of the barbs causing the edges to “bite” into the I.D. of the tubing.

The problem with these known connections is that they are subject to leakage in some circumstances. In certain industries where the material being handled must be pure and not come into contact with air, this can pose problems resulting in wasted material as air getting into the system contaminates the batch of pharmaceutical or biologic which is being made. Another potential problem occurs with the pressure build up in the system, which can cause the filter or sterile connector to blow off and cause leaks or contamination of batch.

Further, for the handling of caustic or bio-hazardous materials, leakage poses further dangers for users.

The industry has been asking for leak proof connections. One prior solution to this has been to apply tie-wraps or band clamps over the tubing section that engages the barbed fitting. This requires extra parts, and does not apply pressure evenly, which can still result in leaks, often resulting in the user applying two clamps or tie-wraps at different orientations. Further, using a tie wrap originally intended for the electrical industry to keep wires together has not proved to be reliable.

It would be desirable to provide a barbed tubing connection that is leak-proof under generally all circumstances required for particular applications.

### SUMMARY

The present invention provides an overmolded sealed connection for a barbed fitting tubing assembly in order to provide a leak-proof connection, for example to a filter or sterile connector. The invention utilizes a thermoplastic tube which is pressed onto a barbed thermoplastic fitting of a device, for example, such as a filter. A thermoplastic sleeve is molded over the tubing where it engages the barbed fitting as well as the end of the fitting where it connects to the device such that the overmolded sleeve engages in an over-mold groove in the fitting so that it is form-locked in position. The tubing, the barbed fitting and the overmolded thermoplastic sleeve are all made of a thermoplastic material and the overmolded thermoplastic sleeve is installed with sufficient heat and/or pressure of the thermoplastic material such that a leak-proof connection is provided between the thermoplastic material of the sleeve and the tubing as well as between the thermoplastic sleeve and the barbed fitting. This can be a cross-linked chemical bond or a physical mechanical interlocked connection, or a combination of both, and provides a leak-proof connection under most circumstances required for a particular application.

The overmolded assembly can be made ahead of time at a factory and the overall assembly then sterilized. Alternatively, the overmolded assembly can be created in situ so that the respective devices and tubing can be assembled as required.

### BRIEF DESCRIPTION OF THE DRAWING(S)

FIG. 1 is a view of a device having two barbed fittings, with the barbed fitting on the left side shown assembled to a piece of tubing with an overmolded sleeve according to the invention, and the barbed fitting on the right side having a piece of tubing engaged along with a tool for over-molding a thermoplastic sleeve to form the leak proof connection.

FIG. 2 is a perspective view showing the device with the overmolded sleeve connecting the tubing on one side.

### DETAILED DESCRIPTION OF THE PREFERRED EMBODIMENT

Certain terminology is used in the following description for convenience only and is not considered limiting. Words such as “top”, “bottom”, “left”, and “right” indicate directions in the drawings to which reference is made, and are not considered limiting. This terminology includes the words specifically noted above and derivatives thereof and words of similar import. Additionally, the terms “a” and “one” are defined as including one or more of the referenced item unless specifically noted.

The preferred embodiment of the invention will be described with reference to the drawings where like numerals represent like elements throughout.

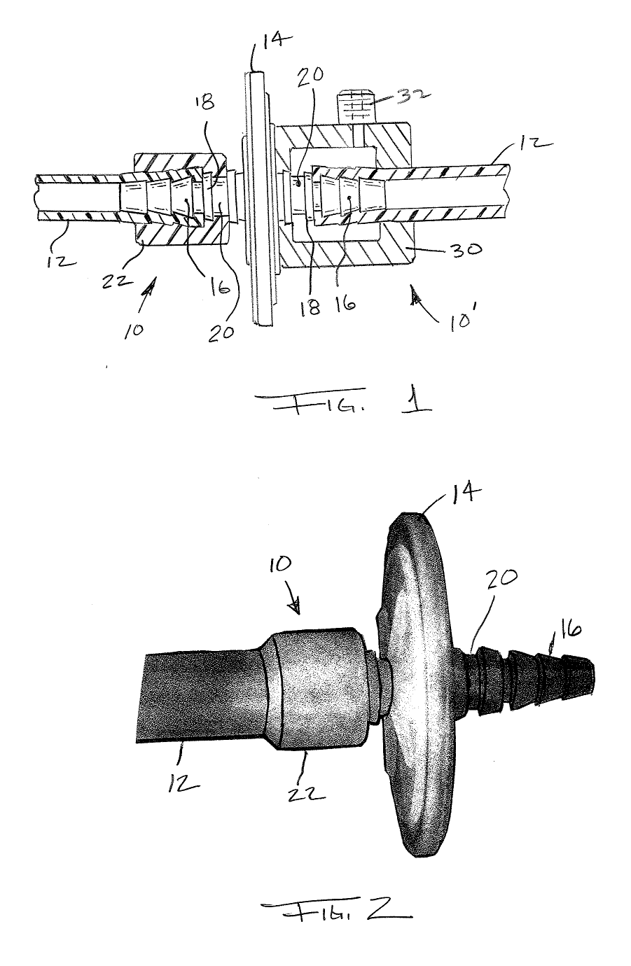

Referring to FIG. 1, an overmolded assembly 10 connecting tubing 12 to a device 14 having a barbed fitting 16 is shown on the left side of the figure. This can be, for example, a sterile connector for bio or pharma processing equipment and tubing. The device 14 can be any type of device, such as a filter as illustrated having two barbed fittings 16, or can be a device such as a thermoplastic bag or container having a single barbed fitting 16. The barbed fitting 16 includes a stop 18 which the end of the tubing 12 is inserted up to and abuts. The overmolded sleeve 22 is formed over the end portion of the tubing 12 as well as a portion of the barbed fitting 16, and preferably is form-locked into an overmold groove 20 on the fitting 16 so that it cannot be pulled off.

Preferably, the tubing 12, the barbed fittings 16 and the overmolded sleeve 22 are all formed of a thermoplastic material, which can be for example a polypropylene, polypropylene mix, or other thermoplastic material. The thermoplastic material used to form the sleeve 22 is molded over the end of the tubing 12 and the barbed fitting 16 and is preferably at a sufficient temperature and/or pressure such that a cross-linked chemical bond occurs between the sleeve 22 and the tubing 12 on the one hand, as well as between the sleeve 22 and the barbed fitting 16. This cross-linked chemical bond forms a leak-proof connection which is leak proof for most conditions. Alternatively, the sleeve 22 is molded over the end of the tubing 12 and the barbed fitting 16 and forms a physical interlocked mechanical connection that forms a leak-proof connection which is leak proof for most conditions. The connection can also be both a cross-linked chemical bond as well as a physical interlocked mechanical connection.

In one sample made by the inventor, a thermoplastic material tubing under the trade name ADVANTAFLEX from NewAge Industries, Inc was joined to a polypropylene barbed fitting. The tubing had an inside diameter of 0.375 inches with a wall thickness of 0.125 inches. The tubing and fitting were pressurized to 70 psi causing the tubing to burst, but not the overmolded sleeve 22. The overmolded sleeve was formed from polypropylene and had a wall thickness that is at least 0.1 inches, and is preferably approximately 0.125 inches.

Still with reference to FIG. 1, the right-side of the figure shows an overmold tool 30 which has been installed over the tubing 12 which has been forced onto the barbed fitting 16 up to the stop 18. The overmold tool is preferably a split tool and can be clamped into position over the tubing 12 and the end of the fitting 16 adjacent to the device 14 creating a mold chamber in which molten thermoplastic material can be injected such that a cross-linked chemical bond and/or physical interlocked mechanical bond is created between the thermoplastic material used to form the sleeve 22 and the tubing 12 as well as between the thermoplastic material used to form the sleeve 22 and the barbed fitting 16. In one preferred embodiment, the thermoplastic material for the sleeve 22 is at least partially of the same as the material used for both the tubing 12 and the barbed fitting 16

While one preferred material for use in connection with the present invention is polypropylene, those skilled in the art will recognize that other thermoplastic materials can be utilized, if desired. Additionally, materials that are not identical can be utilized for forming a cross-linked chemically bonded connection and/or a physical interlocked mechanical bond.

Those skilled in the art will also recognize that the devices 14 can be various devices for single use disposable pharma- or bio-processing as well as other possible uses, such as for sterile connectors. Additionally, while the preferred fitting 16 is barbed, other types of fittings can be utilized without barbs, depending upon the particular application.

What is claimed is:

1. An overmolded connection for a thermoplastic tubing and connector comprising:
tubing inserted over a fitting; and
a sleeve molded over an end of the tubing and a portion of the fitting;
the tubing, the sleeve and the fitting all being formed of at least one thermoplastic material such that at least one of a cross-linked chemical bond or a physical mechanical interlocked connection is formed.

2. The overmolded connection of claim 1, wherein the connection is the cross-linked chemical bond between the sleeve and the tubing and the sleeve and the fitting.

3. The overmolded connection of claim 1, wherein a stop is formed on the fitting, and the end of the tubing contacts the stop.

4. The overmolded connection of claim 3, wherein the sleeve extends over the stop.

5. The overmolded connection of claim 3, wherein an overmold groove is located on the fitting on an opposite side of the stop from the tubing, and the sleeve is form-locked into the overmold groove.

6. The overmolded connection of claim 1, wherein the fitting has a barbed end upon which the tubing is inserted.

7. The overmolded connection of claim 1, wherein the tubing is polypropylene.

8. The overmolded connection of claim 1, wherein the fitting is formed as a part of a device.

9. The overmolded connection of claim 1, wherein the sleeve has a wall thickness of at least 0.1 inches.
